(19) United States
(12) Patent Application Publication
(10) Pub. No.: US 2009/0272494 A1
(43) Pub. Date: Nov. 5, 2009

(54) Laminator

(76) Inventors: Kuan Ting Chen, Taipei Hsien (TW); Wen Chun Yeh, Taipei Hsien (TW)

Correspondence Address: BIRCH STEWART KOLASCH & BIRCH, PO BOX 747, FALLS CHURCH, VA, 22040-0747, US

(21) Appl. No.: 12/149,351

(22) Filed: Apr. 30, 2008

(51) Int. Cl. B29C 65/00

(52) U.S. Cl. 156/367

(57) ABSTRACT

A laminator comprises a main body, having an upper lid mounted thereon, wherein a panel is settled at an obverse side of the upper lid and an assembly hole is formed on the panel. Besides, a touch screen, a spacer, an LCD and a control circuit are successively stacked and then assembled into the assembly hole so as to provide an integrated touch key unit at the panel. Thereby, functional setting items are displayed at the touch screen to allow a convenient, fast and stable operation of the laminator.

### BACKGROUND OF THE INVENTION

1. Technical Field

The present invention relates to a laminator, and more particularly, to an electronics-based laminator having a touch screen that allows a convenient and timesaving operation thereof.

2. Description of Related Art

Laminators are common office appliances for people's paperwork. Please refer to FIG. 3, where a conventional laminator with mechanical function keys is provided. Therein, a panel 51 is typically settled at an obverse side of a main body 50 near an opening at a central portion of the main body 50. Plural knobs 52, buttons 53, and indicator lamps 54 are arranged on the panel 51 for conducting settings with respect to temperature, speed, paper size, film thickness and so on. However, since such mechanical function keys are raised from the panel 51 of the main body 50, an appearance of the laminator is hindered from stylish and streamline design. Besides, while the panel 51 bearing a relatively complex structure is substantially space-consuming, it merely provides a finite space for accommodating function keys, thereby limiting the number of the function keys available thereon and in turn limiting the capability of the laminator. This is an innate drawback of such conventional laminator.

Now referring FIG. 4, another conventional laminator with electronic function keys has primarily a main body 60 and two panels 61, 62 at two edges beside an opening at a central portion of the main body 60. On the panels 61, 62, a plurality of flat keys 63 and at least one LCD 64 are provided. For displaying various functional parameters on the LCD 64, the flat keys 63 may come in an array. For instance, directional keys may include representatives of up (↑), down (↓), left (←), and right (→). While such functional keys crowd the panel, not only a user is liable to misoperation, but also a relatively long operation time is required. Thus, such conventional laminator also has its innate defects.

### SUMMARY OF THE INVENTION

In view of the aforementioned problems with respect to the panel design of the conventional laminators, the inventor of the present invention, with the attempt to improve a panel of a laminator, herein provides a novel laminator as an improvement on the prior art devices.

The primary objective of the present invention is to provide a laminator, which comprises a main body, having an upper lid mounted thereon, wherein a panel is settled at an obverse side of the upper lid and an assembly hole is formed on the panel. Besides, a touch screen, a spacer, an LCD and a control circuit are successively stacked and then assembled into the assembly hole so as to provide an integrated touch key unit at the panel. Thereby, functional setting items are displayed at the touch screen to allow a convenient, fast and stable operation of the laminator.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing a laminator of the present invention;

FIG. 2 is a flow chart showing an operational process of a panel of the present invention;

FIG. 3 is a perspective drawing of a conventional laminator with mechanical function keys; and

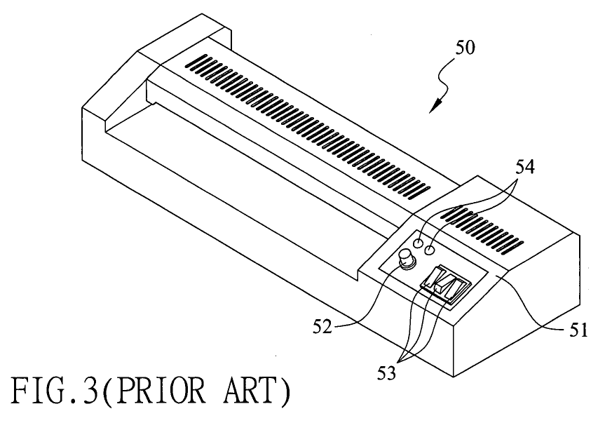

FIG. 4 is a perspective drawing of another conventional laminator with electronic function keys.

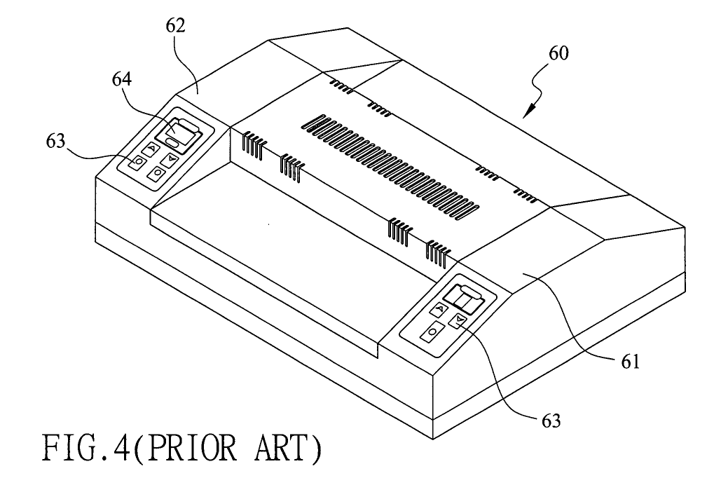

### DETAILED DESCRIPTION OF THE PREFERRED EMBODIMENT

The detail technical features of the present invention will be described in detail in accordance with the accompanying drawings.

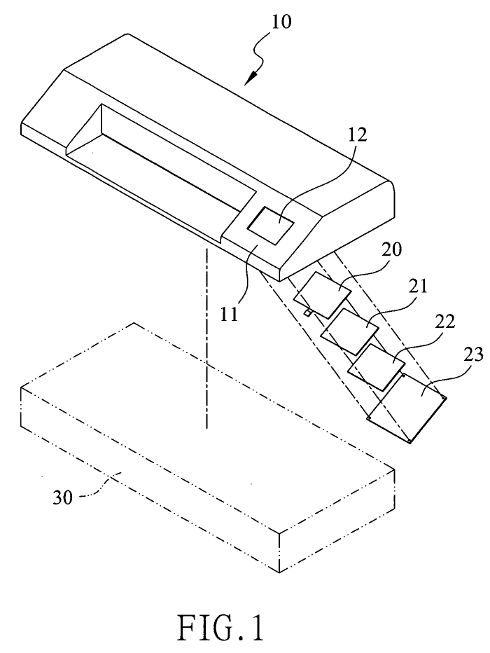

Please refer to FIG. 1. The disclosed subject matter primarily comprises an upper lid 10 mounted on a main body 30 thereof, wherein the upper lid 10 and the main body 30 may be integrally formed. A panel 11 is provided at a proper location on an obverse side of the upper lid 10 and has an assembly hole 12 preformed thereon.

A touch screen 20, a spacer 21, an LCD 22 and a control circuit 23 are successively stacked and then assembled into the assembly hole 12 so as to form an integrated touch key unit.

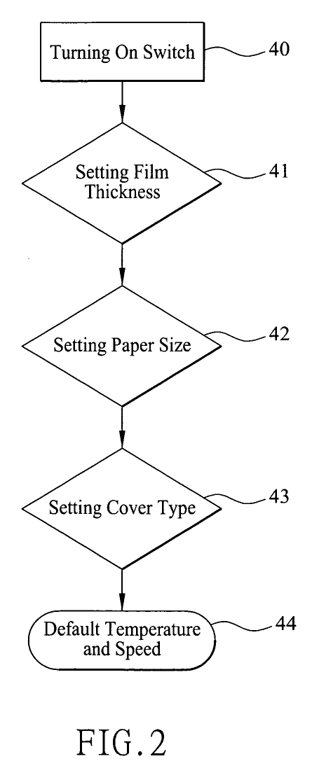

Reference is now made to both FIGS. 1 and 2. By the touch key unit provided at the panel 11 of the main body 30, functional setting items can be directly operated at the touch screen 20 while less space is required for the touch key unit as compared with the conventional function keys, and a more elegant appearance of the overall laminator is possible. In operation, a user can firstly turn on a switch (Step 40) for seeing a plurality of basic functional setting items through the touch screen 20 and then set the thickness of the laminating film (Step 41), the size of the paper (Step 42), the cover type (Step 43) and/or the adjustable default heating temperature and speed (Step 44) in sequence. However, while the foregoing setting sequence can be programmed by means of commercially available software packages, it is not critical to the technical features of the present invention and is not described herein in further detail.

The present invention frees laminators from the conventional rough contour caused by the mechanical function keys and permits a more streamline design of the laminators so as to give a smoother operational experience to users. Besides, the present invention eliminates the risk of misoperation and the need of long operation time of the conventional electronic function keys. Hence, the present invention is indeed industrially utility.

Although the particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A laminator, comprising:
a main body, having an upper lid mounted thereon, wherein a panel is settled at an obverse side of the upper lid and an assembly hole is formed on the panel; and
a touch screen, a spacer, an LCD and a control circuit successively stacked and then assembled into the assembly hole so as to provide an integrated touch key unit at the panel.

2. The laminator as claimed in claim 1, wherein, the upper lid and the main body are formed as an integral.
